(19) United States
(12) Patent Application Publication
(10) Pub. No.: US 2025/0141498 A1
(43) Pub. Date: May 1, 2025

(54) DEVICE AND METHOD FOR UPDATING RIS BEAM

(71) Applicant: Electronics and Telecommunications Research Institute, Daejeon (KR)

(72) Inventors: Sung woo Choi, Daejeon (KR); Hee Sang Chung, Daejeon (KR); Seon-Ae Kim, Daejeon (KR); Junhyeong Kim, Daejeon (KR)

(21) Appl. No.: 18/935,149

(22) Filed: Nov. 1, 2024

(30) Foreign Application Priority Data
Nov. 1, 2023 (KR) 10-2023-0148707
Mar. 8, 2024 (KR) 10-2024-0033123

(51) Int. Cl. H04B 7/04

(52) U.S. Cl. CPC H04B 7/04013

(57) ABSTRACT

A beam updating method in a reconfigurable intelligent surface (RIS) is provided. The method includes: receiving data from a base station using a first polarization and receiving an RIS beamforming reference signal using a second polarization; fixing the reflection direction of the first polarization and sequentially changing the reflection direction of the second polarization to transmit reflected waves; and adjusting the direction of the second polarization based on optimal second polarization direction control information determined according to channel power values corresponding to the reflection direction of the second polarization.

### CROSS-REFERENCE TO RELATED APPLICATION(S)

This application claims priority to and the benefit under 35 USC § 119 of Korean Patent Application No. 10-2023-0148707, filed on Nov. 1, 2023, and Korean Patent Application No. 10-2024-0033123, filed on Mar. 8, 2024, in the Korean Intellectual Property Office, the entire disclosures of which are incorporated herein by reference for all purposes.

### BACKGROUND

### 1. Technical Field

The present invention relates to a device and method for updating the beam of a Reconfigurable Intelligent Surface (RIS).

### 2. Related Art

In conventional mobile communication systems, MIMO (multi-input multi-output) transmission technology has been commonly used. This technology increases channel capacity by transmitting communication signals through multiple antennas and improves the signal-to-noise ratio (SNR) by utilizing path diversity. Current mobile communication standards have introduced technologies such as massive MIMO and extreme MIMO, which further increase the number of antennas to enhance the effectiveness of MIMO transmission.

As the frequency bands in mobile communication increase, array antennas and polarization antennas are becoming more commonly used. Array antennas which are arranged in a two-dimensional configuration, determine the direction, width, and strength of beam. In frequency bands above millimeter wave, these antennas are used to maximize the effect of MIMO transmission. Additionally, dual-polarized antennas, which combine vertical and horizontal polarization, contribute to improving wireless channel capacity.

Various methods are being explored to overcome coverage hole issues that occur at higher frequencies. Among them, signal repeaters and Reconfigurable Intelligent Surfaces (RIS) have gained significant attention. RIS is a reconfigurable surface composed of meta-elements, and a method of overcoming coverage holes through RIS beamforming has been proposed.

However, in mobile communications, there is a lack of protocols regarding the initial setup and update of beams to effectively utilize RIS. Although various methods, such as formula-based calculations and iterative-convergence methods, are being researched, there are still challenges in selecting the optimal beam, and the computational cost remains high. The current beam update process requires channel power measurements for data transmission and reception, which may result in reduced transmission speed and feedback delays, potentially degrading communication performance.

### SUMMARY

Various embodiments disclosed in this disclosure provide an RIS beam updating device and method for updating the beam of a reconfigurable intelligent surface in a mobile communication system that includes a reconfigurable intelligent surface.

According to one embodiment of this disclosure, a method for updating the beam in a reconfigurable intelligent surface (RIS) includes: receiving data from a base station using a first polarization and receiving an RIS beamforming reference signal using a second polarization; fixing a reflection direction of the first polarization and sequentially changing a reflection direction of the second polarization to transmit a reflected wave; and adjusting a direction of the second polarization based on an optimal second polarization direction control information, which is determined according to a channel power values corresponding to the reflection directions of the second polarization.

Additionally, the RIS in a mobile communication system includes: a transceiver that receives data from a base station using a first polarization and receives an RIS beamforming reference signal using a second polarization; and a processor that fixes a reflection direction of the first polarization, sequentially changes a reflection direction of the second polarization to transmit a reflected wave, and adjusts the direction of the second polarization based on an optimal second polarization direction control information, wherein the optimal second polarization direction control information is determined according to a channel power values corresponding to the reflection directions of the second polarization.

Additionally, a base station in a mobile communication system includes a transceiver and a processor. The processor is configured to transmit data to the RIS using a first polarization via the transceiver and transmit an RIS beamforming reference signal using the second polarization to prevent communication interruptions.

A computer program according to another aspect for solving the above-described problems executes the RIS beam updating device and method and is stored on a computer-readable recording medium. Specific details are included in the detailed description and drawings.

According to the aforementioned embodiment, the communication interruption during the RIS beam updating process can be minimized, and a reduction in data transmission capacity can be prevented. Since one of the dual polarizations is used for data transmission, the other polarization can simultaneously transmit the RIS beamforming reference signal. This allows for rapid completion of the RIS beam update without causing communication interruptions.

In general, during the RIS beam update process, a terminal must set up a transmit-receive beam pair for uplink data and allocate time-frequency transmission resources in order to feedback the channel power measured by the base station. However, according to one embodiment, since there is a polarization dedicated to data transmission, downlink and uplink communications can occur at any time. This reduces the time required to feedback measurement values for RIS beamforming and improves the speed of the RIS beam update. As a result, the system can respond quickly to changes in the wireless channel, preventing communication performance degradation that may occur due to delayed RIS beamforming.

Thus, the beam updating device and method for reconfigurable intelligent surfaces (RIS) according to one embodiment provide an effective method for quickly completing RIS beam updates in response to changing wireless channels, without reducing data transmission capacity.

The effects of various embodiments are not limited to those mentioned above, and other effects not explicitly mentioned can be clearly understood by a person of ordinary skill in the art from the following descriptions.

### BRIEF DESCRIPTION OF THE DRAWINGS

FIG. 1 is a drawing illustrating a mobile communication system.

FIG. 2 is a block diagram for explaining each communication node constituting the mobile communication system.

FIG. 3 is a drawing for explaining the concept of a mobile communication system using RIS.

FIGS. 4A and 4B are drawings for explaining signals with dual polarization characteristics.

FIGS. 5A and 5B are flow charts illustrating a method for updating the RIS beam according to one embodiment.

FIGS. 6A and 6B are drawings illustrating examples of reflected waves generated from the input of the first and second polarizations

FIGS. 7 and 8 are drawings illustrating examples of the RIS beam update method according to one embodiment.

FIG. 9 is a drawing schematically illustrating the internal structure of an RIS according to one embodiment.

FIG. 10 is a drawing schematically illustrating the internal structure of a base station according to one embodiment.

### DETAILED DESCRIPTION

The advantages, features, and methods of achieving them will become apparent with reference to the following detailed description of the embodiments, together with the accompanying drawings. However, the present invention is not limited to the embodiments disclosed below but can be implemented in various other forms. The embodiments are provided to ensure the thoroughness of the disclosure and to fully inform those skilled in the art of the scope of the invention, which is defined only by the claims.

Throughout this specification, the term “device” may refer to user equipment (UE), terminal, mobile station (MS), mobile terminal (MT), advanced mobile station (AMS), high-reliability mobile station (HR-MS), subscriber station (SS), portable subscriber station (PSS), access terminal (AT), machine-type communication device (MTC device), or any combination of the functions of UE, MS, MT, AMS, HR-MS, SS, PSS, or AT.

Additionally, the term “base station (BS)” may refer to node B (NodeB), evolved node B (eNB), 5G node B (gNB), advanced base station (ABS), high reliability base station (HRBS), access point (AP), radio access station (RAS), base transceiver station (BTS), mobile multihop relay base station (MMR-BS), relay station (RS) acting as a base station, relay node (RN) acting as a base station, advanced relay station (ARS) acting as a base station, high reliability relay station (HR-RS) acting as a base station, small base stations such as femto base station (femto BS), home NodeB (HNB), home eNodeB (HeNB), pico base station (pico BS), macro base station (macro BS), micro base station (micro BS), and the like. The term may also encompass all or part of the functions of the aforementioned components, including NB, eNB, gNB, ABS, AP, RAS, BTS, MMRBS, RS, RN, ARS, HR-RS, small base stations, etc.

The terms used in this specification are intended to describe the embodiments and are not intended to limit the invention. In this specification, unless explicitly stated otherwise, the singular forms also include the plural. The terms “comprises” and/or “comprising,” as used herein, do not exclude the referred component or addition of one or more other components besides the elements mentioned. Throughout the specification, the same reference numerals in drawing refer to the same components, and “and/or” includes any combination of one or more of the listed components. Although terms like “first”, “second”, etc., may be used to describe various components, they do not imply any limitation by these terms. These terms are only used to distinguish one component from another. Therefore, the first component mentioned below could just as easily be referred to as the second component within the scope of the technical idea.

Unless otherwise defined, all terms (including technical and scientific terms) used herein will be understood as having the same meaning that is commonly used by those of ordinary skill in the art to which this invention belongs. Additionally, terms that are generally defined in dictionaries should not be interpreted ideally or excessively unless explicitly defined otherwise.

Hereinafter, a detailed description of the background will be provided to aid the understanding of those skilled in the art.

In mobile communication systems, MIMO (multi-input multi-output) transmission technology is a method of transmitting communication signals using multiple antennas at both the transmitter and receiver. By utilizing multiple antennas, the wireless channel can be divided into several spatial subchannels, which increases channel capacity. When the same data is transmitted via MIMO, the path diversity effect can improve the signal-to-noise ratio (SNR) of the received signal. MIMO technology, with such advantages, has been widely adopted in almost all mobile communication standards.

Meanwhile, mobile communication systems are evolving to support a wider range of services and more users. For instance, 3GPP has standardized the use of higher frequency bands, such as millimeter-wave (Frequency Range 2: 24-52 GHZ), which is higher than the related art of lower bands (Frequency Range 1: below 6 GHZ). Furthermore, technologies like massive MIMO and extreme MIMO, which increase the number of MIMO antennas, have been adopted.

As the frequency band used for communication increase, array antennas, which allow easy adjustment of gain and directivity, are widely used. An array antenna consists of antenna elements arranged in a two-dimensional layout, and all of the characteristics of the antenna elements are combined to determine beam direction, beamwidth, and beam intensity of the array antenna. In the case of using high-frequency bands such as millimeter waves, a large number of array antenna panels are employed to enhance the effectiveness of MIMO transmission.

Furthermore, to utilize the polarization characteristics of electromagnetic waves, dual-polarized antennas are used, which have both vertical and horizontal polarized antennas in a single antenna. Vertical and horizontal polarizations theoretically propagate without interfering with each other, so that each polarization may form an independent channel. By using this characteristic, the capacity of the wireless channel can be doubled.

5G mobile communications propose using millimeter-wave bands above 24 GHz to support high data rates. In the future, 6G mobile communications, which will require even higher data rates, are being developed to use sub-THz or THz frequencies. However, at frequencies above millimeter waves, the signal attenuation in the atmosphere is significant, and there is less reflection or diffraction, which causes coverage holes where the signal from the base station does not reach the terminal. Coverage holes often occur by buildings and other structures in outdoor environments, and are caused by obstacles such as walls inside buildings.

Various solutions are being considered in existing mobile communications to overcome the coverage holes. The most common method is to use a signal repeater. A repeater amplifies the strength of the received signal and retransmits the amplified signal. While repeaters operate at the physical layer, there are also L2 and L3 relays, which retransmit the received signals at higher layers of the communication protocol. Recently, 3GPP's NR standard has proposed the use of network-controlled repeaters (NCR), which standardize smart repeaters that can be controlled at the network level. NCRs can receive control signals from the base station to manage the beam of transmission and reception signals and support to operate in time division duplex (TDD) mode.

However, for frequencies above millimeter-wave, where the communication range is shorter, a larger number of coverage hole mitigation devices are required. This leads to high installation costs for network operation. Even the simplest repeater requires expensive high-frequency amplifier to amplify the signal after reception.

Recently, reconfigurable intelligent surfaces (RIS) have gained significant attention as a low-cost solution to expand communication coverage. RIS, also referred to as intelligent reflecting surfaces (IRS), are reconfigurable surfaces composed of meta-elements that exhibit artificial reflection characteristics different from natural wave reflection. RIS consists of a two-dimensional array of meta-elements, and by controlling the reflection of these elements, the beamforming of reflected waves can be adjusted. Generally, the reflection control of the meta-elements can be done through adjusting the phase and amplitude of the reflected wave. However, adjusting the amplitude requires amplifiers, which increases power consumption and complicates the meta-elements. On the other hand, passive approach, which use passive elements to control only the phase, are widely developed because of simpler structures, and lower manufacturing costs.

Communication devices using millimeter waves and higher frequencies must find the optimal beam for each other. To achieve this, mobile communication protocols define the procedures for initial beam setup and beam updates. In mobile communication systems including RIS, the beamforming of reflected beams passing through RIS must also be determined. However, existing communication standards only define the beam initialization and update protocols between the base station and the terminal, making them unsuitable for systems that include RIS.

Many studies are being conducted on channel estimation and beamforming setup methods in mobile communication systems that include RIS. The methods for RIS beamforming may be broadly divided into formula-based calculation methods and iterative-convergence methods.

First, the formula-based calculation method calculates the RIS beamforming based on the coordinates of the base station, terminal, and RIS. Another formula-based calculation method involves transmitting pilot signals to determine all channels between the base station-RIS, RIS-terminal, and, if necessary, base station-terminal, after which the beamforming for the base station and RIS is set according to the most suitable channel conditions. The control values for the RIS elements included in the RIS are determined based on the RIS beamforming established by these methods. Next, the iterative-convergence method adjusts the control values of the RIS elements and repeatedly calculates them to either increase signal power or reduce reception errors, thereby converging the control values of the RIS elements.

However, these methods described above require extensive mathematical calculations or long convergence times, making it impractical to find ideal values in real-time for every moment.

Instead, a more practical approach is to use a beamforming table-based optimal beam selection method, similar to what is used in existing mobile communication standards. For this, a beamforming table for the RIS-reflected beams must be created, from which the optimal beam can be selected based on the situation.

In beam-based mobile communication, beam updating involves finding a new transmit-receive beam pair by considering changes in the channel from the currently used transmit-receive beam pair. By fixing the transmit beam and sweeping the receive beam, the optimal receive beam may be identified by checking the receive channel power. Conversely, by fixing the receive beam and sweeping the transmit beam, the optimal transmit beam can be found.

When reference signals are sent for channel power measurement, if data transmission and independent time resources are used for reference signal transmission, no data transmission occurs during that time, leading to a reduction in data transmission speed. Moreover, when RIS beamforming is included in the above situation, this interruption can lead to more frequent decreases in transmission speed. On the other hand, if reference signals share the same time resources with data transmission, data reception performance may degrade or become interrupted depending on the beam direction to be measured.

Additionally, the channel power values measured by the terminal must be fed back to the base station via the uplink. For the feedback process, the uplink slot and the transmit-receive beam pair that is currently connected for communication need to be allocated. However, if the terminal is not using the currently connected beam and switches to another beam to measure channel power, the successful transmission of the feedback signal cannot be guaranteed. Therefore, retransmission of the feedback may be necessary to ensure reliable feedback completion, which can cause delays.

Additionally, if channel power feedback is provided after all completion of beam-sweeping processes, the amount of feedback data increases, leading to further delays until the feedback process is completed. This lengthens the beam update time, slowing the beam update process. If the beam update process is delayed, the system may respond slowly to channel changes, which can degrade communication performance.

To address these issues, the RIS beam updating device and method according to one embodiment are characterized by enabling the efficient selection of the beamforming direction of the reconfigurable intelligent surface (RIS) in a mobile communication system, allowing beam updates to occur. According to one embodiment, the RIS beam updating process can reduce signal interruption, preventing a decrease in data transmission capacity. Furthermore, it improves the RIS beam update speed, allowing for quicker completion of RIS beam configuration.

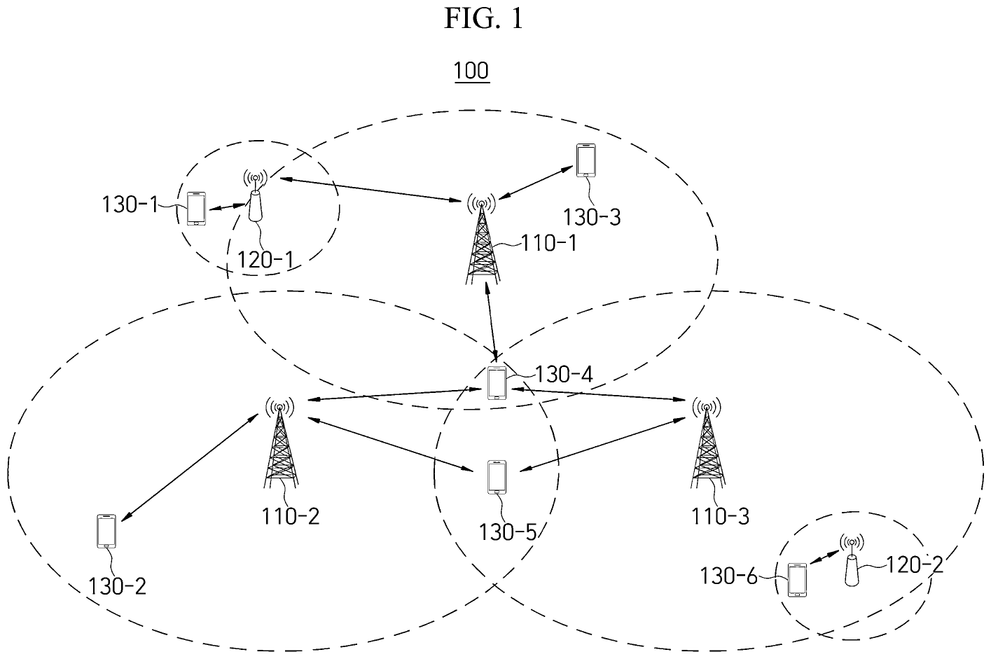

FIG. 1 is a drawing illustrating a mobile communication system. The mobile communication system (100) may include a plurality of communication nodes (110-1, 110-2, 110-3, 120-1, 120-2, 130-1, 130-2, 130-3, 130-4, 130-5, 130-6). These communication nodes may support 4G communication (e.g., LTE [Long Term Evolution], LTE-A [Advanced]) and 5G communication (e.g., NR [New Radio]), as defined by the 3GPP (3rd Generation Partnership Project) standard. 4G communication may operate in frequency bands below 6 GHZ, while 5G communication can operate in both sub-6 GHz and above 6 GHz frequency bands.

For example, for 4G and 5G communication, a plurality of communication nodes support various communication protocols based on CDMA (Code Division Multiple Access), WCDMA (Wideband CDMA), TDMA (Time Division Multiple Access), FDMA (Frequency Division Multiple Access), OFDM (Orthogonal Frequency Division Multiplexing), Filtered OFDM, CP-OFDM (Cyclic Prefix-OFDM), DFT-s-OFDM (Discrete Fourier Transform-spread OFDM), OFDMA (Orthogonal Frequency Division Multiple Access), SC-FDMA (Single Carrier-FDMA), NOMA (Non-Orthogonal Multiple Access), GFDM (Generalized Frequency Division Multiplexing), FBMC (Filter Bank Multi-Carrier), UFMC (Universal Filtered Multi-Carrier), SDMA (Space Division Multiple Access).

Additionally, the mobile communication system (100) may include a core network. If the communication system (100) supports 4G communication, the core network may include an S-GW (serving-gateway), P-GW (PDN [packet data network]-gateway), and MME (mobility management entity). If the communication system (100) supports 5G communication, the core network may include a UPF (user plane function), SMF (session management function), AMF (access and mobility management function) and etc.

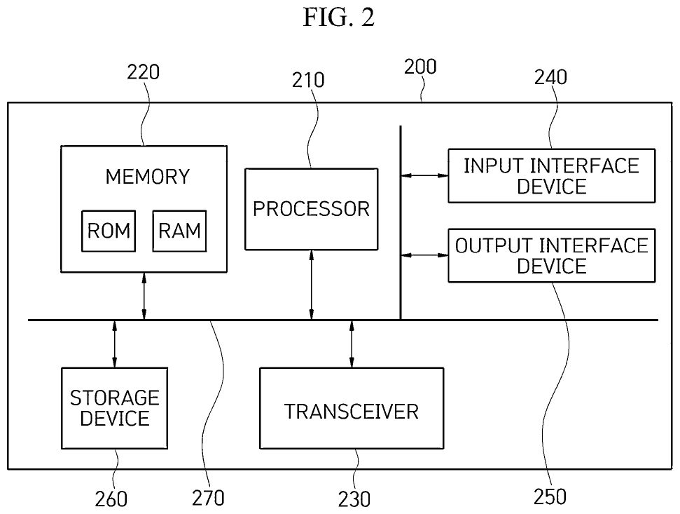

Meanwhile, the plurality of communication nodes (110-1, 110-2, 110-3, 120-1, 120-2, 130-1, 130-2, 130-3, 130-4, 130-5, 130-6) that constitute the mobile communication system (100) may each have the structure shown in FIG. 2.

FIG. 2 is a block diagram that explains each communication node constituting the mobile communication system.

The communication node (200) may include at least one processor (210), memory (220), and a transceiver (230) connected to a network for performing communication. Additionally, the communication node (200) may further include an input interface device (240), an output interface device (250), and a storage device (260). Each component in the communication node (200) may be interconnected via a bus (270) for communication.

However, the components included in the communication node (200) may be connected via individual interfaces or individual buses centered around the processor (210), rather than a common bus (270). For example, the processor (210) may be connected to at least one of the memory (220), transceiver (230), input interface device (240), output interface device (250), and storage device (260) through a dedicated interface.

The processor (210) may execute program commands stored in at least one of the memory (220) or storage device (260). The processor (210) may refer to a central processing unit (CPU), a graphics processing unit (GPU), or a dedicated processor for performing methods in the embodiment. Both memory (220) and storage device (260) may be composed of at least one volatile or non-volatile storage medium. For example, memory (220) may include read-only memory (ROM) and random-access memory (RAM).

Referring back to FIG. 1, the mobile communication system (100) may include a plurality of base stations (110-1, 110-2, 110-3, 120-1, 120-2) and plurality of terminals (130-1, 130-2, 130-3, 130-4, 130-5, 130-6). The mobile communication system (100) including base stations (110-1, 110-2, 110-3, 120-1, 120-2) and terminals (130-1, 130-2, 130-3, 130-4, 130-5, 130-6) may be referred to as an “access network.” The first base station (110-1), second base station (110-2), and third base station (110-3) may each form a macro cell. The fourth base station (120-1) and fifth base station (120-2) may each form a small cell. Within the cell coverage of the first base station (110-1), the fourth base station (120-1), third terminal (130-3), and fourth terminal (130-4) may be located. Within the cell coverage of the second base station (110-2), the second terminal (130-2), fourth terminal (130-4), and fifth terminal (130-5) may be located. Within the cell coverage of the third base station (110-3), the fifth base station (120-2), fourth terminal (130-4), fifth terminal (130-5), and sixth terminal (130-6) may be located. Within the cell coverage of the fourth base station (120-1), the first terminal (130-1) may be located. Within the cell coverage of the fifth base station (120-2), the sixth terminal (130-6) may be located.

Here, the plurality of base stations (110-1, 110-2, 110-3, 120-1, 120-2) may be referred to as NodeB, evolved NodeB (eNB), base transceiver station (BTS), radio base station, radio transceiver, access point, access node, RSU (road side unit), RRH (radio remote head), TP (transmission point), TRP (transmission and reception point), gNB and etc. The plurality of terminals (130-1, 130-2, 130-3, 130-4, 130-5, 130-6) may be referred to as user equipment (UE), terminal, access terminal, mobile terminal, station, subscriber station, mobile station, portable subscriber station, node, device, IoT (Internet of Things) device, mounted module/device/terminal, or on-board device/terminal, etc.

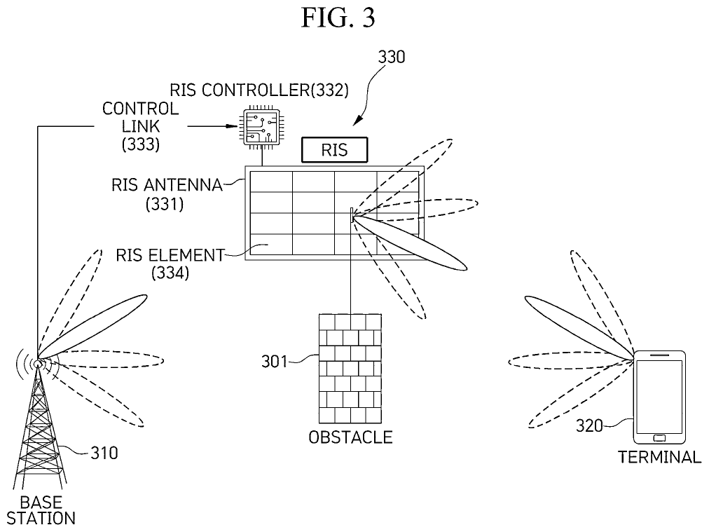

FIG. 3 is a drawing for explaining the concept of a mobile communication system using RIS (reconfigurable intelligent surface). In FIG. 3, the base station (310) and terminal (320) are shown in a non-line-of-sight (NLoS) situation due to an obstacle (301) blocking the line of sight (LoS). In millimeter-wave communication, it is nearly impossible to communicate in an NLoS environment. To overcome this, the reflected waves from the RIS (330) are used to establish a new communication link.

The RIS (330) consists of an antenna (331) made up of a plurality of RIS elements and an RIS controller (332). The RIS controller (332) receives RIS reflection beam setting information via the control link (333). The control link (333) may be activated by the base station (310) or the terminal (320) and may utilize both wireless and wired communication technologies. For example, wireless communication technologies such as 3GPP mobile communication, Wi-Fi, or Bluetooth can be used, while wired technologies can include LAN supporting TCP/IP or fronthaul technology connecting the base station and distributed antennas.

The RIS controller (332) receives the RIS beam setting information via the control link (333) and outputs control information for the RIS elements. For example, the RIS element control information may include n bits that control the phase of the RIS element (334). With n bits, it is possible to control 2ⁿ different reflection phases. The RIS controller (333) is connected to all RIS elements (334) and can adjust their phases. The reflected waves with the adjusted phases are combined to determine the beam direction and intensity of the RIS antenna (331). In the case of dual-polarized communication, the RIS element control information may include phase adjustments for both polarizations.

As shown in FIG. 3, when the base station (310) and terminal (320) use multiple beams but can only use one beam at a time, a beam setting protocol is needed to select the optimal beam combination. A commonly used beam setting protocol is the beam sweeping-selection method. In this method, the transmit beam is fixed, and the receive beam is swept to measure the channel power for each receive beam, determining the optimal receive beam. Conversely, the receive beam can be fixed, and the transmit beam swept to select the optimal transmit beam. Channel power can be measured using indicators such as RSRP (reference signal received power) and RSSI (received signal strength indicator), as defined by 3GPP mobile communication standards.

A base station (310) using dual-polarized communication transmits a beamforming reference signal with dual-polarized characteristics toward the RIS. Here, the beamforming reference signal refers to a synchronization signal, a channel state information reference signal (CSI-RS), or a training sequence. The synchronization signal is transmitted to establish synchronization between the base station (310) and the terminal (320). The channel state information reference signal is sent to measure the state of the wireless channel. Additionally, the training sequence refers to a sequence of signals transmitted prior to data transmission, used for synchronization acquisition and channel equalization.

In the scenario shown in FIG. 3, to complete the beam configuration, it is necessary to find the transmit beam of the base station (310), the reflected beam of the RIS (330), and the receive beam of the terminal (320). Since the positions of the base station (310) and the RIS (330) are generally fixed, assuming the optimal transmit beam of the base station (310) is already set, it is necessary to configure the beams for the RIS (330) and the terminal (320). In FIG. 3, when there are 4 reflected beams from the RIS (330) and 4 beams from the terminal (320), the signal quality for a total of 16 beam combinations is required being calculated to find the optimal beam combination.

To calculate the signal quality, a beamforming reference signal is typically used. The beamforming reference signal is a signal for beam configuration and channel state evaluation. In OFDM transmission, the beamforming reference signal may be transmitted using the same OFDM symbol as the data transmission, or it may be transmitted using a different OFDM symbol. In the latter case, where the beamforming reference signal and data use different OFDM symbols, data transmission is interrupted while the beamforming reference signal is transmitted for channel measurement. In the former case, where the same OFDM symbol is used, data reception performance may deteriorate or data reception may fail when measuring a beam other than the current serving beam.

Additionally, assuming the movement of the terminal (320) in mobile communication, serving beam updates (beam tracking) are continuously required, and new beams must constantly be attempted to find the optimal beam combination. Therefore, interruptions in communication signals are inevitable as the beam pair between the RIS (330) and the terminal (320) is repeatedly searched for.

The RIS beam updating device and method according to one embodiment aim to reduce signal interruptions that occur during the beam configuration process.

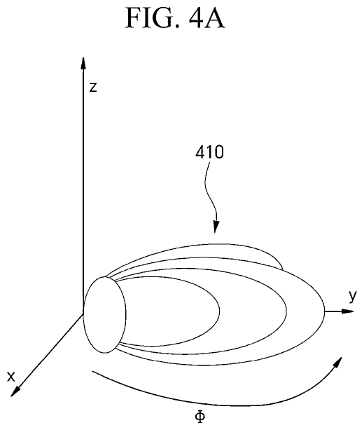

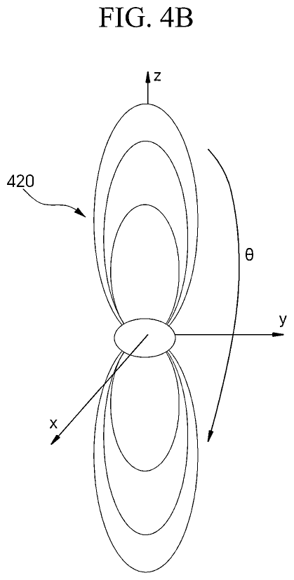

FIGS. 4A and 4B are drawings for explaining signals with dual polarization characteristics. In FIG. 4A, the vertical polarization (410) is shown in the x-y plane according to five azimuth angles (φ), and in FIG. 4b, the horizontal polarization (420) is represented in the x-z plane according to seven elevation angles (θ). FIGS. 4A and 4B demonstrate that the vertical polarization (410) and horizontal polarization (420) are orthogonal to each other and can propagate in various azimuth and elevation angles.

A reconfigurable intelligent surface (RIS) supporting dual polarization can independently control the reflection angles of vertical polarization (410) and horizontal polarization (420). For example, while fixing the vertical polarization (410), the elevation angle of the reflected horizontal polarization (420) can be changed, and while fixing the horizontal polarization (420), the azimuth angle of the reflected vertical polarization (410) can be adjusted.

Based on this, one embodiment proposes a method that utilizes an RIS capable of independently controlling dual-polarized signals to efficiently perform RIS beam updates in a mobile communication system. This embodiment minimizes communication interruptions during the RIS beam update process to prevent a reduction in data transmission capacity and improve the speed of RIS beam updates, allowing the RIS beam configuration to be completed quickly. In other words, the RIS beam update process is carried out efficiently, leading to improved communication performance in the mobile communication system.

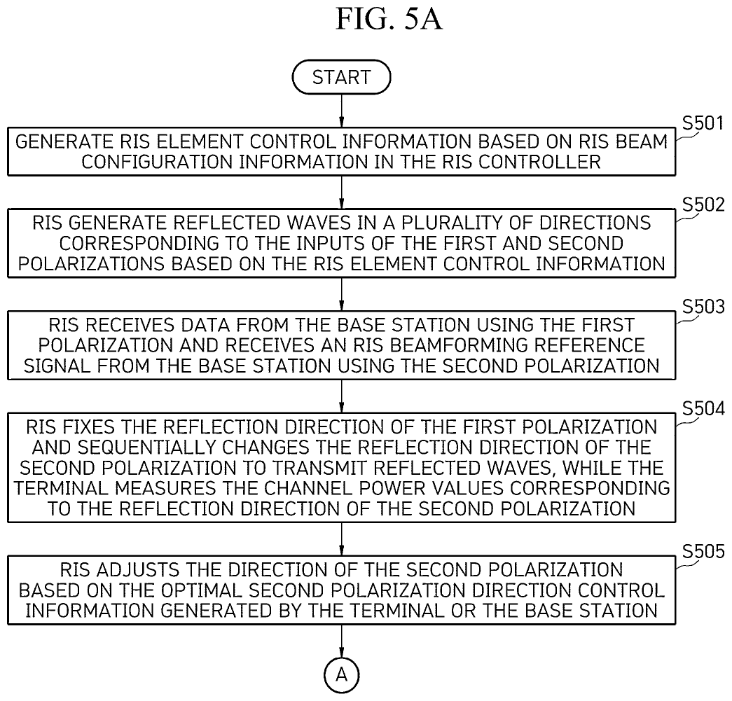

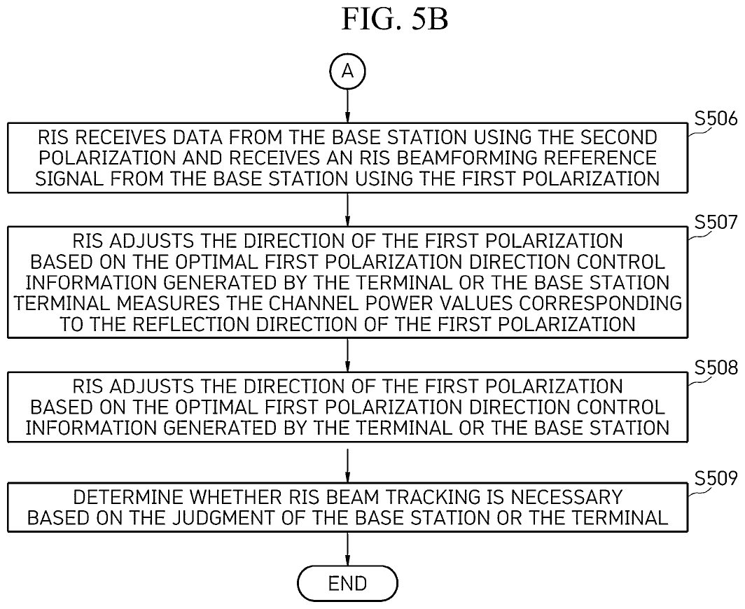

FIGS. 5A and 5B are flow charts illustrating a method for updating the RIS beam according to one embodiment.

First, the RIS controller outputs control information for the RIS elements based on the RIS beam configuration information received via the RIS control link (S501). Accordingly, the RIS generates reflected waves with a plurality of directions based on the input of the first and second polarizations (S502). The first and second polarizations can be either vertical or horizontal. For instance, if the first polarization is vertical, the second polarization is horizontal, and vice versa.

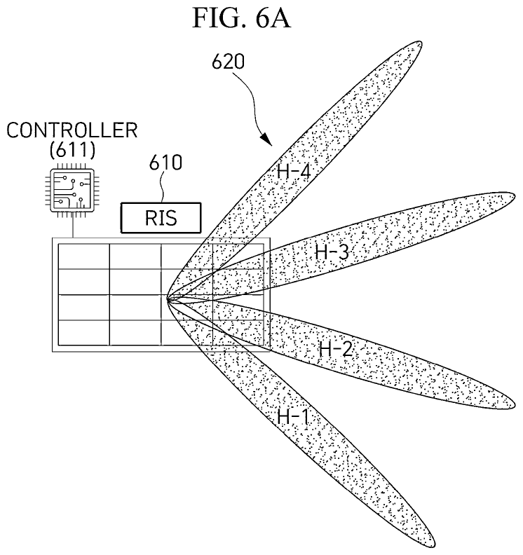

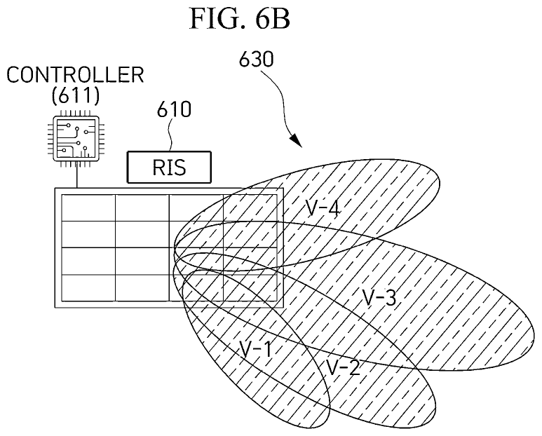

FIGS. 6A and 6B are drawings illustrating examples of reflected waves generated from the input of the first and second polarizations. Referring to FIG. 6A, RIS (610) can generate reflected waves (620) in four directions for the input of the horizontal polarization (H) according to the beam configuration information of the RIS controller (611). The reflected waves (620) generated for the input of the horizontal polarization (H) have four directions: H-1, H-2, H-3, and H-4. Similarly, referring to FIG. 6B, RIS (610) can generate reflected waves (630) in four directions for the input of the vertical polarization (V) according to the beam configuration information of the RIS controller (611). The reflected waves (630) generated for the input of the vertical polarization (V) have four directions: V-1, V-2, V-3, and V-4. In this manner, RIS (610) can independently generate reflected waves (620, 630) in the horizontal and vertical directions according to the beam configuration information, thereby controlling the propagation in a specific direction.

Referring back to FIG. 5A, as the beam update begins, the RIS receives data from the base station using the first polarization and receives a RIS beamforming reference signal from the base station using the second polarization (S503).

Next, as the RIS receives RIS element control information through the RIS controller, it fixes the reflection direction of the first polarization and sequentially changes the reflection direction of the second polarization to transmit the reflected waves. Simultaneously, the terminal measures the channel power values corresponding to the reflection direction of the second polarization (S504).

Next, the terminal transmits the channel power values corresponding to the reflection direction of the second polarization to the base station via the uplink using the first polarization. And the base station can generate the optimal second polarization direction control information based on the received channel power values. Alternatively, the terminal itself can generate the optimal second polarization direction control information based on the channel power values. The determined second polarization direction control information is then transmitted to the RIS controller, and the RIS adjusts the direction of the second polarization based on the second polarization direction control information (S505).

Referring to FIG. 5B, the RIS receives data from the base station using the second polarization and receives the RIS beamforming reference signal from the base station using the first polarization (S506).

Next, as the RIS receives RIS element control information through the RIS controller, the RIS fixes the reflection direction of the second polarization and sequentially changes the reflection direction of the first polarization to transmit the reflected waves. Simultaneously, the terminal measures the channel power values corresponding to the reflection direction of the first polarization (S507).

Next, the terminal transmits the channel power values corresponding to the reflection direction of the first polarization to the base station via the uplink using the second polarization, and the base station can generate the optimal first polarization direction control information based on the received channel power values. Or the terminal itself can generate the optimal first polarization direction control information based on the channel power values. The first polarization direction control information, determined in this way, is transmitted to the RIS controller, and the RIS can adjust the direction of the first polarization based on the first polarization direction control information (S508).

Afterward, if RIS beam tracking is deemed necessary based on the judgment of the base station or the terminal, the process is repeated starting from step S503 or from step S501 (S509).

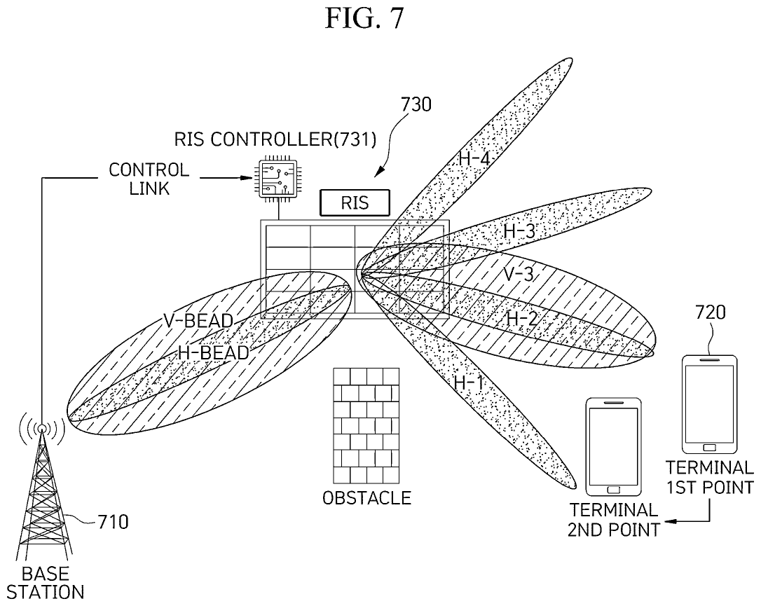

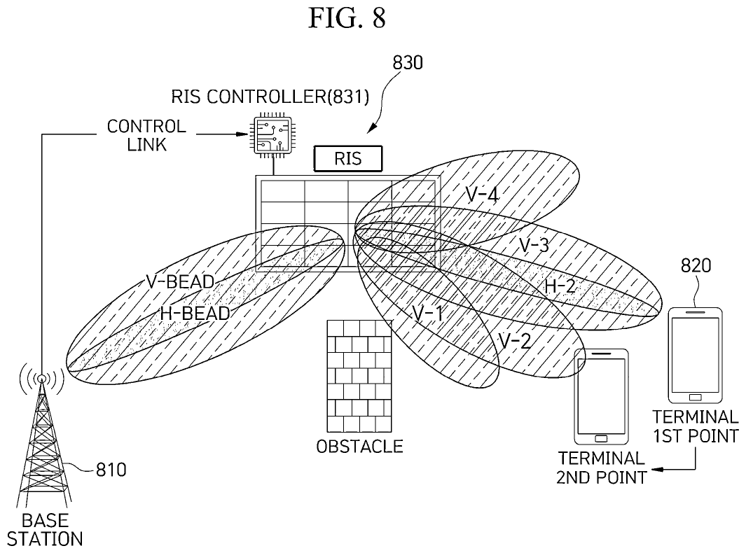

FIGS. 7 and 8 are drawings illustrating examples of the RIS beam update method according to one embodiment.

First, FIG. 7 illustrates a situation where communication between the base station (710) and the terminal (720) occurs via the RIS (730) using dual-polarized signals. In this case, in the examples of FIGS. 7 and 8, the serving beam for the terminal (720, 820) at the first point of the RIS (730, 830) is the first polarization ‘V-3’ and the second polarization ‘H-2’. It is assumed that the terminal (720, 820) moved from the first point to the second point just before the beam update.

When the beam update begins, the base station (710) first transmits data using the first polarization and simultaneously transmits the beamforming reference signal using the second polarization. The RIS (730) fixes the first polarization and sequentially changes the direction of the second polarization, transmitting the reflected waves. In other words, it can transmit reflected waves in the order of H-1, H-2, H-3, and H-4. Simultaneously, the terminal (720) measures the channel power values for each direction of the second polarization, and the channel power values of the second polarization can be sent to the base station (710) via the uplink using the first polarization.

The base station (710) can generate the optimal second polarization direction control information based on the received channel power values of the second polarization. Or, the terminal (720) itself can generate the optimal second polarization direction control information. In the example of FIG. 7, the terminal (720), located at the second point, remains closest to the H-2beam, so the H-2 beam is selected. The second polarization direction control information corresponding to the selected second polarization direction is transmitted to the RIS controller (731), and the RIS (730) adjusts the second polarization direction based on the second polarization direction control information.

In the next step, the base station (810) can transmit data using the second polarization and send the beamforming reference signal using the first polarization. The RIS (830) fixes the second polarization to the H-2 beam and sequentially changes the direction of the first polarization, transmitting the reflected waves in the order of V-1, V-2, V-3, and V-4. Simultaneously, the terminal (820) measures the channel power values for each direction of the first polarization, and the channel power values for the first polarization can be sent to the base station (810) via the uplink using the second polarization.

The base station (810) can generate the optimal first polarization direction control information based on the received channel power values of the first polarization. Or the terminal (820) itself can generate the optimal first polarization direction control information. In the example of FIG. 8, the terminal (820), which has moved to the second point, remains closest to the V-2beam, so the V-2 beam is selected. The first polarization direction control information corresponding to the selected first polarization direction is transmitted to the RIS controller (831), and the RIS (830) adjusts the first polarization direction based on the first polarization direction control information.

By doing so, the RIS can effectively perform beam updates, quickly setting the optimal beam for the moving terminal, thereby improving communication performance.

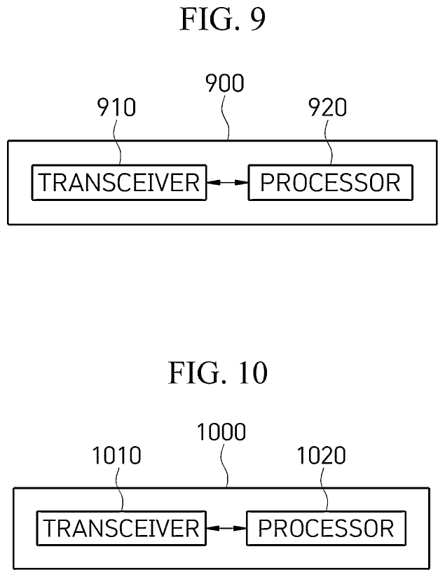

FIG. 9 is a drawing schematically illustrating the internal structure of an RIS according to one embodiment.

Referring to FIG. 9, the RIS (900) may include a transceiver (910) and a processor (920). The transceiver (910) receives data from the base station using the first polarization and receives the RIS beamforming reference signal using the second polarization. The processor (920) may control the overall operation of the RIS in one embodiment. The processor (920) controls the signal flow between blocks to perform the operations described in the procedures outlined in FIGS. 1 to 8. For example, the processor (920) can fix the reflection direction of the first polarization, sequentially change the reflection direction of the second polarization to transmit the reflected waves. And the processor (920) may adjust the direction of the second polarization based on the control information which is determined based on the channel power values of the second polarization.

FIG. 10 is a drawing schematically illustrating the internal structure of a base station according to one embodiment.

Referring to FIG. 10, the base station (1000) may include a transceiver (1010) and a processor (1020). The transceiver (1010) can transmit and receive data to and from the RIS controller, RIS, and terminal. The processor (1020) controls the signal flow between blocks to perform the operations described in the procedures outlined in FIGS. 1 to 8. In one embodiment, the processor (1020) is configured to transmit data to the RIS using the first polarization and transmit the RIS beamforming reference signal using the second polarization via the transceiver (1010) to prevent communication interruption.

Moreover, the processor (1020) can fix the reflection direction of the first polarization in the RIS and sequentially change the reflection direction of the second polarization, transmitting reflected wave, generating the optimal second polarization direction control information based on the channel power values measured at the terminal and thereby transmitting it to the RIS controller.

Meanwhile, in the above description, steps S501 to S509 may be further divided into additional steps or combined into fewer steps according to the implementation. Additionally, some steps may be omitted as necessary, and the order of steps may also be altered. Furthermore, even though not explicitly described, the contents described in FIGS. 1 to 8 can be applied to the contents described in FIGS. 9 and 10, and vice versa.

Meanwhile, the RIS beam update device and method described in the embodiments above can be implemented as a program (or application) stored in a medium and executed in conjunction with hardware, such as a computer. The program described above can include code written in a computer language such as C, C++, JAVA, Ruby, machine code, etc., which the computer's processor (CPU) reads through the computer's device interface to execute the methods implemented by the program. This code can include functional code that defines the necessary functions for executing the methods, and control code for the execution procedures required by the computer's processor to run the functions in the correct order. Additionally, the code can include memory reference-related code that indicates where the necessary information or media should be referenced from, whether located in the internal or external memory of the computer. If remote communication is necessary to execute the functions (for example, with another computer or server), the code can include communication-related instructions on how the computer's communication module should send and receive information or media to and from the remote system.

The storage medium where the program is stored refers to a medium that permanently stores data and is readable by the device, as opposed to volatile storage mediums like registers, caches, or memory used for short-term data storage. Specifically, examples of such permanent storage mediums include ROM, RAM, CD-ROM, magnetic tapes, floppy disks, optical data storage devices, but are not limited to these. In other words, the program may be stored in various recording mediums on servers accessible by the computer or in different recording mediums on the user's computer. Furthermore, The medium can be distributed across a network-connected computer system, and the code readable by the computer can be stored in a distributed manner.

The aforementioned description is provided by way of example, and those skilled in the art to which the present invention pertains will understand that various modifications can be made in specific forms without modifying the technical idea or essential features of the invention. Therefore, the embodiments described above should be understood as illustrative rather than limiting in every respect. For example, each component described as a single unit may be implemented in a distributed manner, and components described as distributed may also be implemented as a combined form.

The scope of the invention should be defined by the following claims rather than the foregoing detailed description, and all modifications or alterations derived from the meaning and scope of the claims and their equivalents should be interpreted as being included within the scope of the invention.

What is claimed is:

1. A method for updating a beam in a Reconfigurable Intelligent Surface (RIS), comprising:
receiving data from a base station using a first polarization and receiving an RIS beamforming reference signal using a second polarization;
fixing a reflection direction of the first polarization and sequentially changing a reflection direction of the second polarization to transmit a reflected wave; and
adjusting the direction of the second polarization based on an optimal second polarization direction control information, wherein the optimal second polarization direction control information is determined according to channel power values corresponding to the reflection directions of the second polarization.

2. The method for updating an RIS beam of claim 1, further comprising:
generating RIS element control information based on an RIS beam configuration information received through an RIS control link by the RIS controller; and
generating the reflected waves in a plurality of directions corresponding to the inputs of the first polarization and the second polarization based on the RIS element control information.

3. The method for updating an RIS beam of claim 1, wherein the channel power values corresponding to the reflection direction of the second polarization are measured by a terminal simultaneously with the transmission of the reflected wave.

4. The method for updating an RIS beam according to claim 3, wherein the terminal generates the optimal second polarization direction control information based on the channel power value.

5. The method for updating an RIS beam of claim 3, wherein the terminal transmits the channel power value corresponding to the reflection direction of the second polarization to the base station via uplink using the first polarization, and the base station generates the optimal second polarization direction control information based on the received channel power values.

6. The method for updating an RIS beam of claim 1, wherein the first polarization and the second polarization are respectively one of a vertical polarization and a horizontal polarization, respectively.

7. The method for updating an RIS beam of claim 1, further comprising:
receiving data from the base station using the second polarization after adjustment of the second polarization direction is completed, and receiving the RIS beamforming reference signal using the first polarization;
fixing the reflection direction of the second polarization and sequentially changing the reflection direction of the first polarization to transmit another reflected waves; and
adjusting a direction of the first polarization based on an optimal first polarization direction control information, which is determined according to a channel power values corresponding to the reflection direction of the first polarization.

8. In the RIS of a mobile communication system, the RIS comprises:
A transceiver configured to receive data from a base station using a first polarization of a dual-polarized signal and to receive an RIS beamforming reference signal using a second polarization; and
A processor configured to fix a reflection direction of the first polarization and sequentially change a reflection direction of the second polarization to transmit reflected waves, and to adjust a direction of the second polarization based on an optimal second polarization direction control information, which is determined according to channel power values corresponding to the reflection direction of the second polarization.

9. The RIS of claim 8, wherein the processor generates RIS element control information based on the RIS beam configuration information received from the base-station; and
the transceiver receives the RIS element control information from the processor, and generates the reflected waves in a plurality of directions corresponding to the input of the first polarization and the second polarization based on the RIS element control information.

10. The RIS of claim 8, wherein the channel power values corresponding to the reflection direction of the second polarization are measured by terminal simultaneously with the transmission of the reflected waves.

11. The RIS of claim 10, wherein the terminal generates the optimal second polarization direction control information based on the channel power values.

12. The RIS of claim 10, wherein the terminal transmits the channel power values corresponding to the reflection direction of the second polarization to the base station via uplink using the first polarization, and the base station generates the optimal second polarization direction control information based on the received channel power values.

13. The RIS of claim 8, wherein the first polarization and the second polarization are respectively one of vertical polarization and horizontal polarization.

14. The RIS of claim 8, wherein upon completion of the adjustment of the second polarization direction, the transceiver receives data from the base station using the second polarization and receives the RIS beamforming reference signal using the first polarization, and the processor fixes reflection direction of the second polarization and sequentially changes reflection direction of the first polarization to transmit reflected waves, adjusting direction of the first polarization based on an optimal first polarization direction control information determined according to another channel power values corresponding to the reflection directions of the first polarization.

15. A base station in a mobile communication system, comprising:
a transceiver; and
a processor,
wherein the processor is configured to transmit data to an RIS using a first polarization and transmit an RIS beamforming reference signal using a second polarization through the transceiver to prevent communication interruption.

16. The base station of claim 15,
wherein the processor is configured to fix a reflection direction of the first polarization at the RIS, sequentially change a reflection direction of the second polarization to transmit reflected waves, and generate an optimal second polarization direction control information based on channel power values measured by a terminal, to transmit the RIS controller.

17. The base station of claim 16,
wherein the transceiver is configured to receive the channel power values from the terminal via uplink using the first polarization as the channel power values corresponding to the reflection direction of the second polarization are measured by the terminal simultaneously with the transmission of the reflected waves.

18. The base station of claim 16,
wherein the processor, after completing the adjustment of direction of the second polarization in the RIS, fixes the reflection direction of the second polarization in the RIS and sequentially changes the reflection direction of the first polarization to transmit another reflected waves, and generates control information for optimal first polarization direction based on another channel power values measured by the terminal, and transmits the optimal first polarization direction control information to the RIS controller.

19. The base station of claim 15,
wherein the first polarization and the second polarization are respectively one of a vertical polarization and a horizontal polarization.
